(19) United States
(12) Patent Application Publication
(10) Pub. No.: US 2009/0053586 A1
(43) Pub. Date: Feb. 26, 2009

(54) BIPOLAR BATTERY INCLUDING A PRESSURE SENSOR

(75) Inventors: Lars Fredriksson, Taby (SE); Richard Howlett, Denver, CO (US)

Correspondence Address: CAPITOL IP, PLLC, PO BOX 1210, VIENNA, VA, 22183, US

(73) Assignee: NILAR INTERNATIONAL AB, Taby (SE)

(21) Appl. No.: 12/279,717

(22) PCT Filed: Feb. 15, 2007
(86) PCT No.: PCT/EP2007/051467

§ 371 Date: Aug. 16, 2008

(30) Foreign Application Priority Data
Feb. 17, 2006 (SE) 0600353-7

(51) Int. Cl. H01M 2/12; H01M 2/18; H01M 10/04; H01M 10/48

(52) U.S. Cl. 429/57; 429/61; 429/210; 320/147

(57) ABSTRACT

The present invention relates to a bipolar battery provided with a pressure sensor. The battery is provided with a housing 7 containing common gas space 97. The pressure sensor 10; 20; 50; 63; 80; 111 comprises: an actuator 3, 21; 31; 41; 48; 81 configured to transfer an internal pressure P within the common gas space to a reciprocal movement, and a switching device 5; 83 configured to generate a control signal indicative of changes in relation to an initial switching state generated by said reciprocal movement when the internal pressure exceeds a predetermined upper level. The pressure sensor further comprises a reset means 4; 32; 81 to automatically reset the switching device to the initial switch state when the internal pressure goes below a predetermined lower level, whereby said control signal is based on the internal pressure (P) within said sealed common gas space. The present invention also relates to a method for charging bipolar batteries.

### TECHNICAL FIELD

The present invention relates to a bipolar battery having a common pressure chamber including a pressure sensor. The invention also relates to a method for charging a plurality of bipolar batteries having a pressure sensor.

### BACKGROUND TO THE INVENTION

During charging of a battery, e.g. a bipolar battery, the temperature will increase due to the chemical reaction that occurs and the pressure inside each cell will also increase due to internal gassing caused by the chemical reaction. One way of controlling the charging of the battery is to monitor the temperature and adapting the amount of energy put into the battery in response to the temperature variations, but it is more advantageous to use the internal pressure to control the charging characteristics since the pressure is a better indicator of the chemical reaction that takes place inside the battery.

The problem with monitoring the internal pressure is that a pressure sensor must be present in each cell, unless a common pressure chamber is used within the battery, to monitor the amount of pressure inside all the battery cells. The environment inside the battery is highly corrosive, e.g. containing potassium hydroxide, and sensors not adapted to this environment will break down. On the other hand sensors that will endure the environment are extremely expensive.

An example of a bipolar battery with a common pressure chamber may be found in the published international application WO 03/026042.

EP 0 739 047 A2 discloses a safety device that includes a membrane separating the inside of the battery from the safety device. Furthermore, the device includes a disk spring which deforms and activates the safety device when a pressure on the membrane is too high. The disk spring has to be manually reset before the battery can resume operation.

EP 0 930 662 A2 discloses a current interrupt apparatus that uses a diaphragm influenced by the pressure inside the battery and that will break allowing pressurized electrolyte escape through apertures. There is no possibility to reset the apparatus to reuse the battery without replacing the diaphragm.

A safety device, or pressure sensor, including an automatic reset is disclosed in EP 1 076 350 A2. The safety device comprises a foil diaphragm that may snap between a convex and a concave shape in dependency of the internal gas pressure inside a battery. The membrane moves a switch blade of shape memory alloy from a contact surface to close an electric circuit, see FIG. 29. When the pressure dissipate the foil diaphragm returns to its initial state (convex shape). A control signal indicative of the pressure inside a single battery cell is thus obtained that could be used to control a charging circuit.

A drawback with the prior art pressure sensor is that it is provided in each battery cell which makes it expensive to implement.

Thus, there is a need for a pressure sensor that can be used for several battery cells to control the charging procedure for all cells simultaneously.

### SUMMARY OF THE INVENTION

An object with the invention is to provide a pressure sensor that can be used for controlling the charging current from a power supply to a bipolar battery comprising multiple battery cells having a gaseous interconnection to create a common gas space.

This object is achieved by a bipolar battery comprising a pressure sensor. The pressure sensor is provided with means to transform a change in internal pressure to a reciprocal movement, and a switching device that is affected by the reciprocal movement. A switch position, which in an initial position of the switching device, e.g. closed circuit between two contacts, may be changed from the initial position to another position, e.g. open circuit between the two contacts, to indicate that the pressure inside a sealed gas space is too high. The switch position will be reset to the initial position when the pressure inside the gas space is reduced. The state of the switch is determined by the position of the switch.

Another object of the invention is to provide a method for charging a plurality of batteries. A pressure sensor that automatically indicate an unacceptable high pressure level inside a sealed common gas space inside a battery will change the charging procedure, e.g. by turning off the charging current for all batteries connected to the power supply, and the charging process is resumed when the pressure inside all sealed common gas spaces are below a lower pressure level.

The essence of the invention is to provide a pressure sensor that monitors the pressure in all battery cells a bipolar battery, and that automatically will regulate the charging process depending on the internal pressure of the battery, e.g. by closing or breaking a circuit that will allow the charging process to start or stop dependent on the internal pressure in the common gas space of any bipolar battery, especially if the bipolar batteries are connected in series.

The stress vs. strain relationship, e.g. the spring constants and stiffnesses of all the components that transmit the motion to the switching device need to be chosen to determine the pressure at which the switching occurs, or in the case with a strain gauge, the strain measured in the gauge.

In a preferred embodiment it may be desirable to deliberately make the part of the mechanism that comprises the gas envelope of the battery (such as a bellows, bladder, or balloon) much more mechanically compliant, i.e. with a much lower spring constant, to reduce the influence of the mechanism on the precise pressure at which the switching takes place. The material for the bellows, bladder, or balloon may be optimized for properties like hydrophobicity and sealing, and not have to have tight tolerances on its elastic properties.

An advantage with the bipolar battery according to the invention is that it is very inexpensive to implement, especially since a common gas space is used for all cells within the battery.

Another advantage with the bipolar battery according to the invention is that a more controlled charging procedure may be used that prevents the housing of the battery from breaking due to excessive internal pressure.

Still another advantage with the method of charging the battery according to the invention is that only the actual pressure inside the battery needs to be sensed to determine the charging procedure, compared to using the temperature as a charging controlling variable. Of course, the temperature of the battery may additionally be sensed. This may be desirable in some specialized applications of a battery and charging system.

Other objects and advantages will become apparent for a skilled person from the following description.

### BRIEF DESCRIPTION OF THE DRAWINGS

FIG. 1 shows a first embodiment of a pressure sensor according to the present invention.

FIG. 2 shows a second embodiment of a pressure sensor according to the present invention.

FIG. 3 shows a third embodiment of a pressure sensor according to the present invention.

FIG. 4 shows an alternative embodiment of an actuator used in the present invention.

FIG. 5 shows a fourth embodiment of a pressure sensor with a lever mechanism according to the present invention.

FIG. 6 shows a schematic view of a first charging arrangement for serial connected batteries provided with a pressure switch according to the invention.

FIG. 7 shows a charging diagram for one battery connected to the charging arrangement in FIG. 6.

FIG. 8 shows a fifth embodiment of a pressure sensor according to the present invention.

FIG. 9 shows a bipolar battery according to the invention.

FIG. 10 shows a battery stack with a common gas space and a pressure sensor according to the invention.

FIG. 11 shows a schematic view of a second charging arrangement for serial connected batteries provided with a pressure switch according to the invention.

### DETAILED DESCRIPTION OF THE PREFERRED EMBODIMENTS

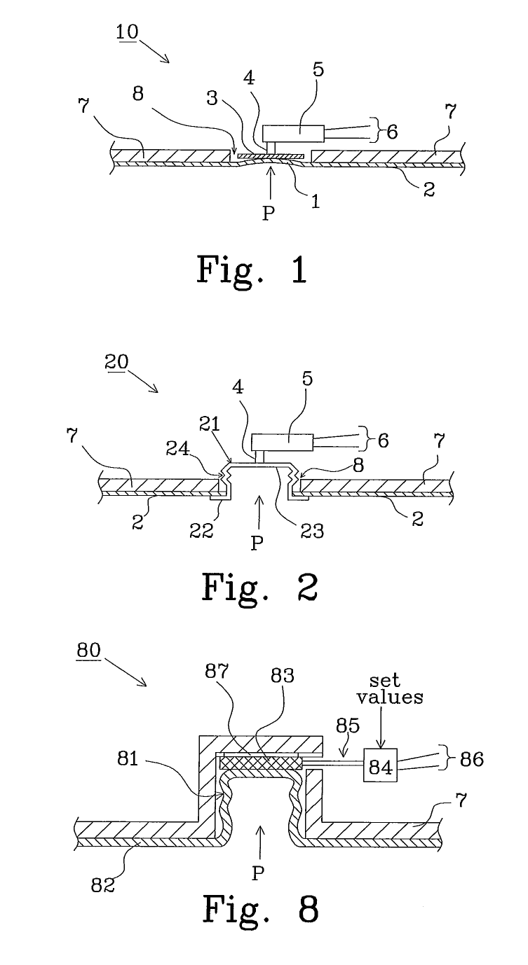

The invention provides a solution wherein an inexpensive sensor may be used to monitor the pressure without having to be in contact with the corrosive environment inside the battery cells. Each cell, or a common gas space (pressure chamber), is provided with a membrane made of a material that will move in a predetermined direction when the pressure inside a battery cell changes during charging, or discharging. The membrane could be made from a material that will withstand the internal corrosive environment, e.g. rubber, stainless steel. The basic principle is described in FIGS. 1 and 2.

The concept of the invention can be summarized to transform the internal pressure of the battery, for each cell or all cells at once, to a movement that will affect a contact of a switch, such as a micro switch, or affect a strain gauge. An increased internal pressure will generate an outgoing movement that affects the switch and the switch generates a control signal indicative of the increased internal pressure. When the pressure decreases, an ingoing movement is generated and the switch is affected in such a way that the generated control signal is indicative of the decreased internal pressure. This is more described in connection with the preferred embodiments below.

The sensor 10 in FIG. 1 comprises a rubber membrane 1, which could be a part of a hydrophobic barrier 2 that prevents intercellular electrolyte leakage. A stiff item 3, such as a metal plate, is provided on top of the membrane 1 opposite to the corrosive side. A pressure P will act on the inside of the membrane, i.e. the corrosive side, and cause the membrane to move in the direction of the arrow in response to an increased pressure due to the membranes 1 elasticity. The rigid item 3 will move and a contact 4 on a switch 5, preferably a micro switch, such as a DG sub subminiature switch available from Cherry Corporation, will be affected, i.e. pushed into the switch 5, and create a control signal by either short circuit the wires 6 or create an open circuit depending of the design of the switch. When the pressure decreases, the elasticity of the membrane will cause the membrane to move in an opposite direction of the arrow, and a built-in spring force acting on the contact 4 in the switch 5 will strive for bringing the contact 4 back to its extended position, as illustrated in FIG. 1. A reciprocal movement is achieved that will affect the switch and thus generate a control signal indicative of the internal pressure in the battery. The membrane is arranged on the inside of a housing 7 and the membrane is placed in an opening 8 in the housing 7.

The sensor 20 in FIG. 2 comprises a metallic insert 21 with a bellows 24, which is provided through the opening 8 in the housing 7. The metallic insert 21 is provided with a flange 22 at a first end and a sealed plate 23 at a second end with the bellows 24 interposed between the flange 22 and the sealed plate 23. Furthermore, the metallic insert 21 is provided through an opening in the hydrophobic barrier 2 in such a way that the flange 22 create a pressure seal with the hydrophobic barrier 2, and thus an increased generated pressure P will move the sealed plate 23 in the same direction as the arrow due to the flexibility of the bellows 24. The bellows is designed to strive to regain its initial shape when the pressure decreases thus moving the sealed plate 23 in a direction opposite to the direction of the arrow. The reciprocal movement will cause the contact 4 on the switch 5 to be affected and either short circuit the wires 6 or create an open circuit depending of the design of the switch as described in connection to FIG. 1.

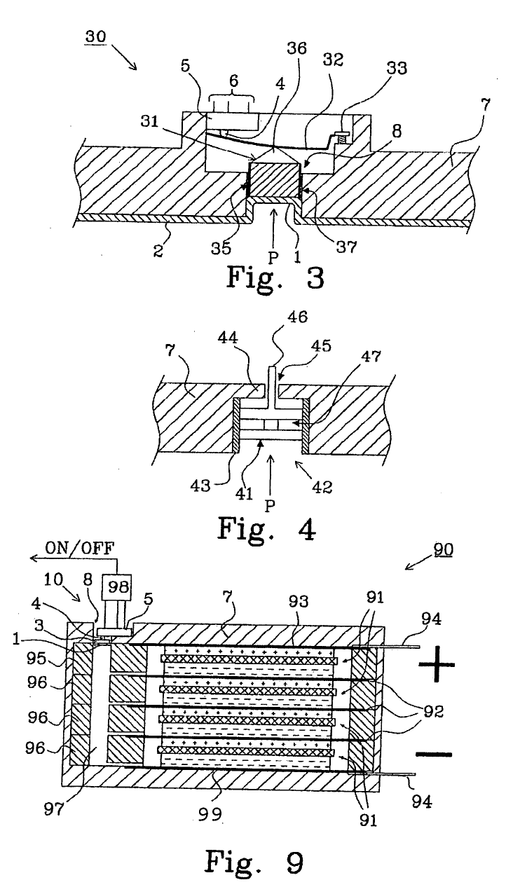

FIG. 3 shows a third embodiment of a pressure sensor 30 provided with an adjustable spring arrangement. A pressure P from inside the battery cell is transformed into a reciprocal movement of the membrane 1, being a part of the hydrophobic barrier 2, as described in connection with FIG. 1. The membrane 1 acts as a balloon when the pressure P is applied from the inside due to the elasticity of the membrane 1. A moving item 31, hereafter called actuator, is placed inside the opening 8 of the housing 7, and on top of the membrane 1 opposite to the corrosive side of the membrane 1.

The adjustable spring arrangement, which is a pressure control means, comprises a spring 32 and a setting screw 33. The actuator 31 will affect the spring 32, and the spring constant can be set by adjusting a setting screw 33. The spring 32 is supported by the housing 7. A pressure increase will then affect the shape of the spring 32, that eventually will affect the contact 4 on the switch 5 and either short circuit the wires 6 or create an open circuit depending on the design of the switch.

The basic operation of the switch 5 is the same as described in connection with FIGS. 1 and 2 with the addition that the pressure control means is used to set an upper pressure level and/or a lower pressure level. The position of the setting screw 33 and the choice of spring 32 material are mainly used to obtain a predetermined upper level for the internal gas pressure by turning the setting screw 33. When the internal pressure exceeds the upper level, the charging process is stopped and halted until the internal pressure drops down below a predetermined lower level. When the internal pressure decreases, the spring 32 will strive to regain its initial shape and the contact 4 will also move back to its extended position. The choice of material of the spring 32 will determine at which predetermined lower level the spring regains its initial shape and thus the pressure inside the battery is acceptable to continue the charging process. If desired, the predetermined lower level may be determined by turning the setting screw, and the predetermined upper level may be determined by the choice of spring 32 material.

When the internal pressure of the battery changes, the actuator moves reciprocally, and in this embodiment, the actuator 31 is coated with a low friction material 35, such as Teflon®, to reduce the friction against an inner surface of the opening 8, and a cone-shaped top surface 36 that abut against the spring 32. Furthermore, the inner surface of the opening 8 is preferably coated with a low friction material 37 to further improve the reciprocal movement of the actuator 31 when the internal pressure changes. The actuator 31 may naturally be manufactured from a single piece of low friction material instead of being coated.

FIG. 4 show an alternative embodiment of an actuator with a stop arrangement. The membrane and switch has been omitted for clarity, but the described actuator may be implemented in any of the previous described pressure sensors 10, 20 and 30. FIG. 4 discloses an actuator 41 inserted into an opening 42 in a housing 7. An insert 43 is provided in the opening 42 that is made from a low friction material. A stop arrangement comprises a shoulder 44 provided around the opening 42, thereby defining a smaller opening 45 through which a pin 46 being a part of the actuator 41 extends. The shoulder 45 prevents the insert 43 and the actuator 41 from leaving the opening 42 when the internal pressure P increases. The membrane (not shown) will prevent the actuator 41 from leaving the opening 42 when the pressure decreases.

The actuator has an essentially flat bottom surface, a circumventing side surface, preferable adapted to the shape of the opening 42, and a top surface on which the pin 46 is arranged. A U-shaped groove 47 is provided around the circumventing surface, thereby reducing the amount of material, and thus the weight, of the actuator 41. The actuator 41 may naturally be coated with, or consist of, a low friction material.

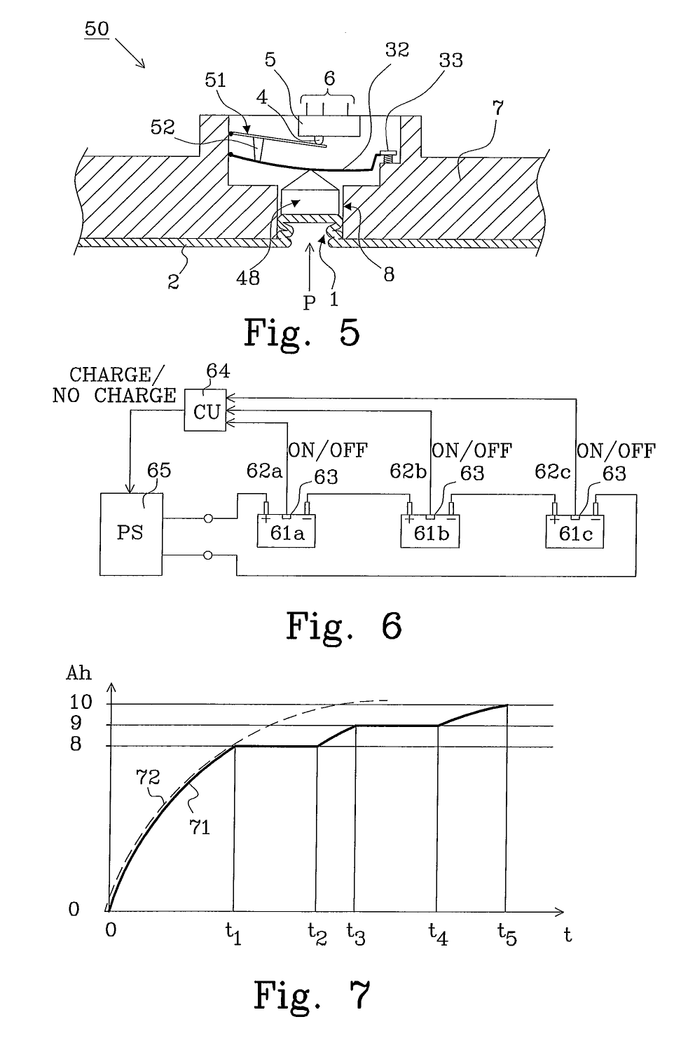

FIG. 5 shows a fourth embodiment of a pressure sensor 50 comprising a lever mechanism to make it more sensitive for a change in internal pressure P. A membrane 1 in the shape of a sealed bellow, said membrane being a part of the hydrophobic barrier 2, is provided into an opening 8. An actuator 48 is provided between the membrane 1 and the spring 32. A lever mechanism in the shape of a lever 51 with a protrusion 52 is provided, said protrusion being in contact with said spring and one end of the lever 51 being supported by the housing 7. The contact 4 of the switch 5 is in contact with a second end of the lever 51.

FIG. 8 shows a fifth embodiment of a pressure sensor 80 comprising a bellows, bladder, or balloon structure, 81 formed in a gas tight outer seal 82, such as a membrane made from a hydrophobic barrier. A strain gauge 83, such as a piezo resistive MPX pressure sensor silicon device available from Freescale Semiconductor, is provided on top of, and in contact with, the bellows 81. Wires 85 are provided from the strain gauge through a casing, wherein the strain gauge 83 is pressed against the casing 7 when an internal pressure P increases. The stress/strain characteristics of the material of the strain gauge is known and well defined from the manufacturer, and an analogue signal is available at the wires 6 that indicate the amount of contact pressure on the strain gauge 83. Preferably, the bellows 81 in the membrane 82 has a much smaller spring constant and larger mechanical compliance than the material in the strain gauge 83, so dependence of the strain gauge signal on the bellows 81 is reduced to be very small. Furthermore, it is also possible to deposit the strain gauge 83 directly onto the bellows 81. Optionally, the wires 85 from the strain gauge 83 is connected to a control signal generator 84 wherein a control signal indicative of the pressure inside the battery is generated. Set values for a predetermined upper level and/or lower level are introduced and a control signal similar to the control signal generated in the previous embodiments is generated at the output wires 86.

A strain gauge is very inexpensive, and by placing it outside the membrane 82 and inside of the casing 7, contact with the corrosive interior of the battery cell is avoided. Most strain gauges used to make a pressure sensor rely on knowing the stiffness of the substrate with which the strain gauge is in contact. If the gauge substrate is up against the case 7, then the readings will not account for this additional stiffness and result in an artificially low pressure measurement. However, a small hollow volume 87 between gauge 83 and the case 7 will provided a correct performance of the strain gauge 83. If a strain gauge sensor on a ceramic substrate is used the membrane 81 may not be necessary, if the ceramic is chemically compatible. The analogue signal from the wires 85 can be used to monitor the charging procedure of the battery, as described in connection with FIGS. 6 and 7. In a general sense, the strain gauge can be regarded as a switching device whose state is determined by the electrical characteristics of the strain gauge. This state varies with the pressure sensed inside the battery.

FIG. 6 shows a battery charge arrangement 60 for charging three serially connected batteries 61a, 61b and 61c using a power supply PS. Each battery has a pressure sensor 63, similar to the pressure sensors as described in FIGS. 1-5 and 8, in communication with a common gas space for all battery cells within each battery, whereby a control signal 62a, 62b and 62c is obtained from each battery and fed into a control unit CU 64. If any of the three received control signals is “OFF” and indicate that the internal pressure is too high, i.e. the switch position of at least one pressure switch is pushed from its initial position by the internal pressure (or the analogue signal indicates a too high internal pressure), then the CU 64 issues a “NO CHARGE” signal to the power supply PS 65. However, if all control signals received by the CU 64 are “ON”, and indicate that the internal pressure is below an acceptable level, i.e. the switch position of all pressure sensors are in the initial position (or the analogue signal indicates an acceptable level of pressure), then the CU 64 issues a “CHARGE” signal to the PS 65.

Alternatively, the charging rate may be changed when the internal pressure in one of the battery cells is too high. For instance, the charging rate might be slowed down, or charge for a fixed time after reaching pressure before turning off the charge. The pressure switch 63 may signal the charger that the end of the charging cycle is near, but the charge need not immediately be terminated.

FIG. 7 shows an example of a charging diagram with a charging curve 71 (fat solid line) for one of the batteries in FIG. 6 together with a corresponding normal charging curve 72 (dashed line) for the same battery without a pressure controlled charging procedure.

From t=0 to t=t₁, the two curves are identical, but at t₁ the CU 64 turn of the PS 65 since one of the batteries 61a, 61b or 61c has an internal pressure being higher than the predetermined upper level, e.g. 30 psi. No charge current is supplied to the batteries until t=t₂ when the internal pressure is below the predetermined lower level, e.g. 25 psi, in all batteries. Then the charging of the batteries continues until the internal pressure once again exceeds the predetermined upper level in one of the batteries at t=t₃. The procedure is repeated and no charge current is supplied to the batteries until t=t₄ and the charging process continues until t=t₅.

If a constant charging current is used during the charging process, the curves in FIG. 7 should be straight lines, where the slope of the line indicates the charging current. The curved lines in FIG. 7 indicate a change in charging current over time.

Furthermore, if the pressure sensor according to FIG. 8 is used, a feedback loop may be used to regulate the current to a level which is necessary to maintain a constant pressure during charge for some or all of the time during charge. This is advantageous when a quick charge is desired at first, and a more gentle charge is desired at the end of the charging cycle.

This type of pressure sensor is preferably applied in a NiMH bipolar battery having a common gas space, as disclosed in the published international applications WO 03/026042 and WO 2005/048390 assigned to the same applicant.

FIG. 9 shows a bipolar battery 90 with a common gas space within a casing 7. The bipolar battery comprises in this example four cells 91 provided in a battery stack, adjacent cells are separated by a biplate 92, which is an electrically conductive metal sheet. A positive endplate 93, provided with a terminal connector 94, is arranged at one side of the battery stack. A negative endplate 95, also provided with a terminal connector 94, is arranged at the opposite side of the battery stack. A frame 95 and 96 of hydrophobic material, to prevent electrolyte leakage between adjacent cells, is provided around the periphery of each cell 91 and a gas channel is provided through the frames 95, 96 to obtain a gas manifold with a gaseous interconnection between the battery cells 91 thereby creating a common gas space 97 for all battery cells. Each cell 91 comprises a positive electrode, a separator provided with electrolyte, and a negative electrode.

A pressure sensor 10 has been arranged in the casing 7, as described in more detail in connection with FIG. 1, and a membrane 1 has been provided in frame 95 closest to the pressure sensor 10. A rigid plate 3 is provided on the outside of the membrane and a switch 5 with a contact 4 is arranged in contact with the rigid plate 3. A control signal generator 98 is attached to wires from the switch 5 and a control signal (ON/OFF) is generated depending on the internal pressure in the common gas space.

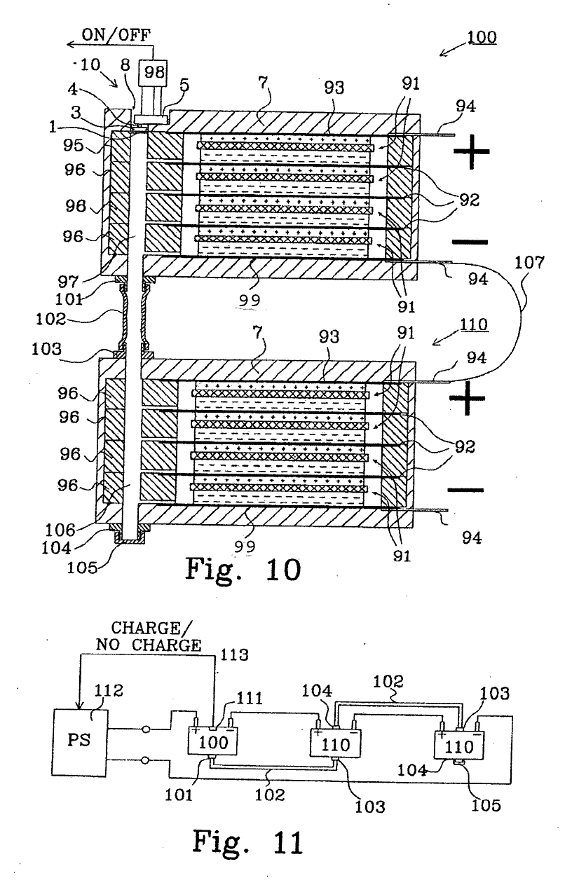

FIG. 10 shows a battery stack arrangement, comprising two bipolar batteries 100 and 110. A first bipolar battery 100 comprises the same parts as the bipolar battery described in connection with FIG. 9 with one exception. A gas manifold port 101 is provided through the casing 7 whereby access to the common gas space 97 within the bipolar battery 100 is provided through the gas manifold port. A first end of a tube 102 is connected in a sealing manner to the gas manifold port 101, and a second end of the tube 102 is connected in a sealing manner to a first gas connection port 103 on an additional battery 110. The first gas connection port 103 is provided through the casing 7 and in communication with a common gas space 106 within the additional battery 110, thereby creating a common gas space for both bipolar batteries 100 and 110. A second gas connection port 104 may be present through the casing 7 and in communication with the common gas space 106 within the additional bipolar battery 110. Further bipolar batteries may be connected to the second gas connection port 104, as illustrated in FIG. 11, or a seal may be provided. The seal may be implemented as a pressure relief valve 105, or a pressure relief valve (not shown) may be incorporated in the first bipolar battery 100. The same type of frame 96 are provided in the additional bipolar battery, since a membrane 1 is not desired, as in the frame 95 closest to the pressure sensor 10 attached to the first battery 100. The positive terminal of the additional battery may be attached to the negative terminal of the first battery as indicated by the line 107.

FIG. 11 shows a schematic view of a second charging arrangement for three serial connected batteries 100, 110 provided with a pressure sensor 111 according to the invention. Only one control signal 113 is provided from the pressure sensor 111 provided in the bipolar batter 100. An interconnecting tube 102 creates a common gas space for all three batteries, and a power supply (PS) 112 provide power to the batteries. In this example the bipolar batteries 100, 110 are connected in series to the PS 112.

1. A chargeable bipolar battery comprising:
a sealed housing;
multiple cells having a gaseous interconnection to create a common gas spaced for said multiple cells; and
a pressure sensor directly mounted on said bipolar battery, said pressure sensor including
an actuator configured to transfer an internal pressure P within said common gas space to a reciprocal movement,
a switching device configured to generate a control signal indicative of changes in the internal pressure in the common gas space of the bipolar battery in relation to an initial switching state, said control signal is generated by said reciprocal movement when the internal pressure exceeds a predetermined upper level, and
a reset means to automatically reset the switching device to the initial switch state when the internal pressure goes below a predetermined lower level,
whereby said control signal is configured to monitor the internal pressure P within said sealed common gas space.

2. The bipolar battery according to claim 1, wherein said pressure sensor is provided with pressure control means for adjusting the predetermined upper level and the predetermined lower level.

3. The bipolar battery according to claim 1, wherein a membrane is provided to create a barrier between a corrosive side of the membrane and the actuator, and to create a sealed common gas space, said membrane is elastic and a shape of the membrane is affected when the internal pressure P changes.

4. (canceled)

5. The bipolar battery according to claim 3, wherein an opening is provided through said housing into said common gas space, and the membrane is provided to seal said opening, the membrane has excessive material arranged close to the opening, and said excessive material is moved in a direction towards the actuator when the internal pressure P increases, and is moved in a direction away from the actuator when the internal pressure P decreases under influence of the reset means.

6. The bipolar battery according to claim 5, wherein the excessive material is shaped as a bellow, bladder, or balloon.

7. The bipolar battery according to an) of claim 3, wherein said actuator is a stiff material arranged adjacent to said elastic membrane, wherein the affected membrane will cause the actuator to move reciprocally.

8. The bipolar battery according to claim 7, wherein said actuator comprises:
an essentially flat bottom surface, which is arranged adjacent to the membrane,
a circumventing side surface arranged to fit into an opening provided in said housing, and
a top surface that will move reciprocally depending on the internal pressure P.

9.-14. (canceled)

15. The bipolar battery according to claim 8, wherein said top surface of the actuator is provided with a pin, and said opening in the housing comprises a shoulder defining a smaller opening through which said pin of the actuator extends, whereby the actuator is prevented from leaving the opening when the internal pressure P increases.

16. The bipolar battery according to claim 2, wherein said pressure control means is provided with an adjustable spring arrangement which is arranged between the actuator and the switching device, and a lever mechanism is provided between the adjustable spring arrangement and the switching device.

17. (canceled)

18. The bipolar battery according to claim 1, wherein said switching device is a strain gauge supplying a signal indicative of the internal pressure P.

19. The bipolar battery according to claim 3, wherein said membrane is a part of a hydrophobic barrier that prevents intercellular electrolyte leakage within the bipolar battery.

20. The bipolar battery according to claim 19, wherein the membrane is more mechanically compliant than the hydrophobic barrier.

21. The bipolar battery according to claim 3, wherein an opening is provided through said housing into said common gas space, and a membrane and actuator are integrated into a metallic insert with a flange in a first end, an interposed metallic bellow, and a sealed plate at a second end to ensure a maintained sealed common gas space, wherein the metallic bellow is arranged through the opening, and the sealed plate will move reciprocally depending on the internal pressure P.

22. The bipolar battery according to claim 1, wherein said bipolar battery is adapted to be charge by a power supply, which power supply is controlled by the state of the switching device.

23. The bipolar battery according to claim 1, wherein said bipolar battery is provided with a gas manifold port being in communication with the common gas space, said gas manifold port is configured to receive a tube, said tube is in communication with an additional common gas space of at least one additional bipolar battery, thereby creating a common gas space for the at least two bipolar batteries.

24. The bipolar battery according to claim 23, wherein each additional bipolar battery is designed without a pressure sensor and provided with a first gas connection port for connecting said tube, said first gas connection port being in communication with said additional common gas space.

25. The bipolar battery according to claim 24, wherein said additional battery further is provided with a second gas connection port being in communication with the additional common gas space, said second gas connection port is configured to be connected to a common pressure relief valve for all bipolar batteries.

26. A method for charging multiple bipolar batteries each being provided with a common gas space as defined in claim 1, wherein a power supply is connected to terminals of the multiple bipolar batteries, and a control signal indicative of changes in internal pressure in the common gas space of each bipolar battery, which control signal depends on the state of each switching device, is used to monitor an internal pressure P within said common gas space and to control the power supply.

27. The method according to claim 26, wherein the power supply, which is charging all batteries, is turned off if any of the switching devices change from the initial switch state, and the power supply is turned on when all switching devices are reset to the initial switch state.

28. The method according to claim 26, wherein a charging current supplied to the bipolar batteries is controlled by the internal pressure of the batteries.

29. The method according to claim 26, wherein the terminals of said batteries are connected in series with the power supply.

30. The method according to claim 26, wherein the common gas spaced of each bipolar battery is provided with a gas manifold port to create a common gas space for said multiple bipolar batteries, and said control signal indicates changes in internal pressure in the common gas space for all bipolar batteries using one pressure sensor.

31. A battery stack arrangement comprising multiple bipolar batteries each being provided with a common gas space as defined in claim 1, each bipolar battery is provided with terminals configured to be connected to a power supply, and a control signal indicative of changes in internal pressure in the common gas space of each bipolar battery, which depends on the state of each switching device, is used to control the power supply.

32. The battery stack arrangement according to claim 31, wherein the common gas space of each bipolar battery is in communication through gas manifold ports provided in each bipolar battery to create a common gas space for said multiple bipolar batteries, and said battery stack arrangement is provided with one pressure sensor configured to provide a single control signal indicative of changes in internal pressure in the common gas space to the power supply.

33. The battery stack arrangement according to claim 32, wherein the communication is provided by a tube attached to the gas manifold ports.
